(19) United States
(12) Patent Application Publication
(10) Pub. No.: US 2025/0389313 A1
(43) Pub. Date: Dec. 25, 2025

(54) BELTS WITH INCREASED FLEXIBILITY FOR PERSONAL MOBILITY, AUTOMOTIVE AND INDUSTRIAL APPLICATIONS

(71) Applicant: GATES CORPORATION, Denver, CO (US)

(72) Inventors: Thomas S. Moss, III, Englewood, CO (US); Bobbie E. South, Columbia, MO (US); Maggie Sackse, Englewood, CO (US); William Williams, Englewood, CO (US); Alex Warneke, Englewood, CO (US)

(73) Assignee: GATES CORPORATION, Denver, CO (US)

(21) Appl. No.: 18/879,963

(22) PCT Filed: Jun. 27, 2023
(86) PCT No.: PCT/US2023/026373

§ 371 Date: Dec. 30, 2024

Related U.S. Application Data
(60) Provisional application No. 63/356,564, filed on Jun. 29, 2022.

(51) Int. Cl. F16G 1/28; F16G 1/10; F16G 1/12

(52) U.S. Cl. CPC F16G 1/28; F16G 1/10; F16G 1/12

(57) ABSTRACT

Endless belts, such as for use with e-bikes and other personal mobility systems such as standard bicycles, wheelchairs, scooters including electric scooters, and other systems that utilize a belt for transmitting power to impart motion to the system. The belts are particularly suited for inhibiting “tooth jumping” during use. In some embodiments, at least a portion of the teeth of the belt are formed from a different material than the body of the belt, the material of the teeth having a higher modulus than the material of the body. The belts can utilize load carrying cords, such as carbon cords.

### CROSS-REFERENCE TO RELATED APPLICATION(S)

The present application claims the benefit of priority to U.S. Provisional Patent Application No. 63/356,564, entitled “Belts with Increased Flexibility for Personal Mobility, Automotive and Industrial Applications”, filed on Jun. 29, 2022, the entirety of which is hereby incorporated by reference.

### BACKGROUND

Industrial belts, such as power transmission belts, generally work in concert with a gear or sprocket that engages the belt and moves the belt upon rotation of the gear or sprocket. One issue that may arise with respect to such systems is “tooth jump”. Tooth jump occurs when a tooth of the belt slips over a tooth of the gear or sprocket it is engaged with. Tooth jump may occur when the belt/teeth are not sufficiently rigid and durable when under a load. For example, an insufficiently rigid belt/tooth may stretch under load, which may lead to tooth jump. Accordingly, a need exists for belts having limited elongation (extension, or stretch) when under load while still exhibiting a relatively high modulus.

### SUMMARY

The present disclosure is directed to toothed belts, such as for use with e-bikes and other personal mobility systems such as standard bicycles, wheelchairs, scooters including electric scooters, motorcycles, and other systems that utilize a belt for transmitting power to impart motion to the system. The toothed belts can also be used in systems that conventionally use a chain and a sprocket(s) or gears to transmit power, such as in drive systems, including the mobility systems described above. The toothed belts can also be used in industrial drive systems and automotive applications.

The belts of this disclosure are particularly suited for inhibiting “tooth jumping” during use, improving belt lifetime, reducing noise generation, and improving overall system efficiency. The belts have a reduced bending stiffness or high flexibility, with a low elongation. These properties can be obtained with the overall belt having a high breaking strength, e.g., no less than 1,300 N/mm, in some implementations no less than 1,400 N/mm. The belts can be homogeneous, the backing of the belt being formed from a low modulus, highly flexible compound, whereas the teeth of the belt, or at least a portion of the teeth, are formed from a high modulus compound.

The modulus of these compounds, whether a low modulus or a high modulus, is rubber modulus, different from Young's modulus or standard modulus. Rubber modulus is a force at a specified elongation, rather than the standard Young's stress over strain. As used herein, “modulus” refers to rubber modulus as defined as a force at the specified elongation.

The modulus is measured in the mill direction, or, with grain direction. If the compound has a reinforcing material such as fiber therethrough (referred to as fiber loaded), the material is pulled at a rate of 6 inches per minute, whereas if it is free of reinforcing fiber, it is pulled at a rate of 20 inches per minute. All references herein to rubber modulus (force at specified elongation) will be in the mill or with grain direction. Also as used herein, “M10” and “M10 modulus” represent the force to obtain 10% elongation.

In some embodiments, the low modulus compound has an M10 modulus of no more than 1,000 PSI at 10% elongation and the high modulus compound has an M10 modulus of at least 2,000 PSI at 10% elongation.

In some embodiments, load carrying fiber cords, such as carbon cords, are present in the low modulus, highly flexible compound. Flexible belts (e.g., having a flexibility of at least 3 mm per 10 N of incremental load) having low elongation (e.g., less than 0.25% at 1,500 N of incremental load) have a low tendency to crimp/kink. Other embodiments are also described and recited herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is perspective view of a portion of a belt according to this disclosure.

FIG. 2 is a perspective view of a portion of another belt according to this disclosure.

FIG. 3A is a perspective view of a portion of yet another belt according to this disclosure.

FIG. 3B is a side cross-sectional view of a portion of the belt shown in FIG. 3A.

FIG. 4A is a side cross-sectional view of a portion of another example belt according to this disclosure.

FIG. 4B is a side cross-sectional view of a portion of another example belt according to this disclosure.

FIG. 5 is a graphical representation of belt power loss as a function of load, which represents efficiency.

FIG. 6 is another graphical representation of belt extension as a function of load, which represents flexibility.

FIG. 7 is a graphical representation of belt flexibility as a function of load.

### DETAILED DESCRIPTION

As described above, described herein are belts particularly suited for mobility purposes, belts that have an ability to avoid elongation (extension, or stretch) when under load.

In the following description, reference is made to the accompanying drawing that forms a part hereof and in which is shown by way of illustration at least one specific embodiment. The following description provides additional specific embodiments. It is to be understood that other embodiments are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

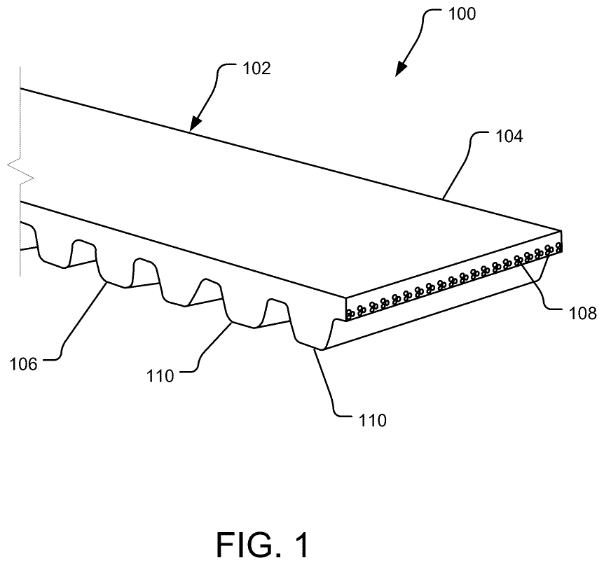

FIG. 1 shows one embodiment of a belt 100 according to this disclosure, the belt 100 being cut to show a cross-section thereof. The belt 100 has a body portion 102 formed of a flexible material (described below) having a back side 104 and a front side 106 with a plurality of load carrying cords 108 within the body portion 102, the particular cords 108 bound in triplicate bundles. The cords 108 may be, e.g., carbon cords, polymeric cords (e.g., polyester, aramid), fiberglass cords, metal cords, ceramic cords, etc.; more than one type of cord may be present. Defined in the front side 106 are a plurality of teeth 110; in this implementation, trapezoidal teeth are depicted in FIG. 1 but the tooth shape is not limited thereto and can take any shape that is compatible with a sprocket or gear. Each individual tooth 110 extends perpendicular to the longitudinal length of the belt 100 and perpendicular or essentially perpendicular to the load carrying cords 108, so that the plurality of teeth 110 run along or around the length of the belt 100. In use, the teeth 110 on the front side 106 are in contact with a drive mechanism, e.g., a toothed gear or sprocket. Although not seen in FIG. 1, the belt 100 is an endless belt, having the form of a loop with no beginning and no end.

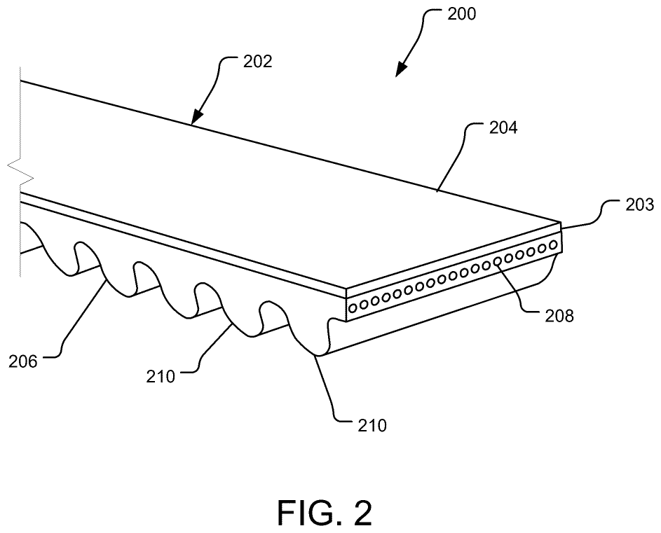

FIG. 2 shows another belt 200 according to this disclosure cut to show a cross-section thereof. The belt 200 has a body portion 202 formed of a flexible material having a back side 204 and a front side 206 with a plurality of load carrying cords 208 within the body 202. This belt 200 further includes a backing 203 on the back side 204 of the body portion 202; this backing 203 may be, e.g., a reinforcing mesh, such as nylon, at least partially embedded in or engulfed by the body 202, and may sometimes be referred to as an overcord. The backing 203 may improve resistance to environmental factors such as friction (wear), oil, coolant, heat, etc., and inhibit mechanical cracking that can develop as a result of prolonged exposure. In some embodiments, the backing 203 may include a rubber stock or polymer different than that forming the body portion 202.

Defined in the front side 206 of the body portion 202 are a plurality of teeth 210, in this implementation, rounded teeth. Each individual tooth 210 extends perpendicular to the longitudinal length of the belt 200, so that the plurality of teeth 210 run along or around the length of the belt 200. In use, the teeth 210 on the front side 206 are in contact with a drive mechanism, e.g., a toothed gear or sprocket. Although not seen in FIG. 2, the belt 200 is an endless belt, having the form of a loop with no beginning and no end.

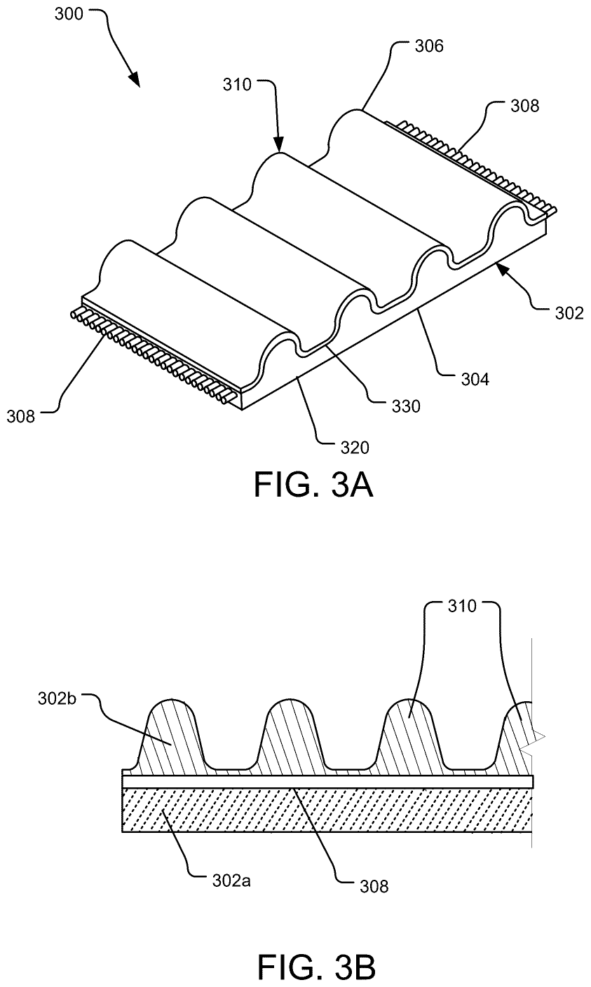

FIGS. 3A and 3B shows a perspective and side cross-sectional view, respectively, of another belt 300 according to this disclosure. The belt 300 has a back side 304 and a front side 306. The belt 300 includes a main body portion 302 formed of two different flexible materials as described in greater detail below. A plurality of load carrying cords 308 are located within the body 302. Defined in the front side 306 of the belt 300 are a plurality of teeth 310. As shown in FIGS. 3A and 3B, the teeth 310 are rounded teeth, though any shape can be used for the teeth 310. Each individual tooth 310 is aligned perpendicular to the longitudinal length of the belt 300, so that the plurality of teeth 310 run along or around the length of the belt 300. However, the teeth 310 can also be oriented in other non-perpendicular orientations. The belt 300 may also include a cover layer 330 (shown in FIG. 3A) disposed over the teeth as is well known in the industry. In use, the teeth 310 on the front side 306 are in contact with a drive mechanism, e.g., a toothed gear or sprocket. Although not seen in FIG. 3A, the belt 300 is an endless belt, having the form of a loop with no beginning and no end.

The belt 300 shown in FIGS. 3A and 3B includes a body portion 302 that is made of at least two materials. The first portion 302a, which may include the portion of the body 302 closest to the back side 304 and may extend into the teeth 310, is comprised of a first material, while the second portion 302b, which may extend from the front side 306 and include at least a portion of the teeth 310, is comprised of a second material different from the first material. In this configuration, at least the outer portion of the teeth 310 (i.e., the portion of the teeth closest to the front side 306) is formed of the second material, while a portion of the body 302 from the back side 304 to, e.g., cords 308, is formed from the first material. The thickness of the second portion 302b may be, e.g., 1.5 mm thick, or e.g., 2 mm thick. The second portion 302b including the second material may form the entire tooth 310 or only part of the teeth 310. The cords 308 may be engulfed in either the first portion 302a or the second portion 302b or may be located at the intersection of the two portions 302a, 302b. Thus, various configurations of the first portion 302a, composed of the first material, and the second portion 302b, composed of the second material, are envisioned.

In the configuration in FIG. 3B, the first portion 302a forms the portion of the body 302 closest to the backside 304 and the second portion 302b forms the teeth 310, with the load carrying cords 308 essentially forming the divide between the two portions 302a, 302b. However, and amount of material, either form the first portion 302a or the second portion 302b is present between the individual cords 308 to at least partially engulf or encapsulated the cords 308 in order to maintain structural integrity of the belt 300.

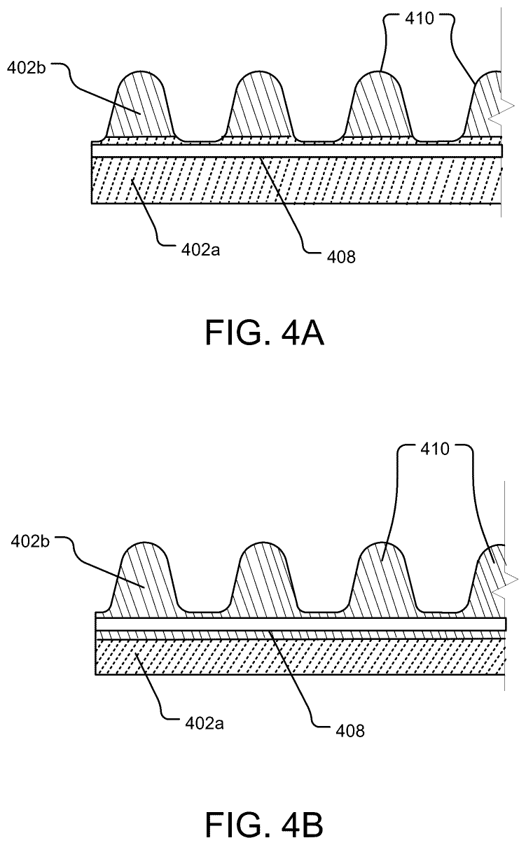

Two additional configurations are shown in FIGS. 4A and 4B. In FIG. 4A, the first portion 402a including the first material forms the body and fully engulfs or encapsulates the load carrying cords 408; the first portion 402a extends partially into the teeth 410 forming a portion of the teeth 410. The second portion 402b including the second material forms the majority of the teeth. In FIG. 4B, however, the second portion 402b forms the teeth 410 and encapsulates the load carrying cords 408, and the first portion 402a forms the portion of the body closest to the back side.

The first material, forming the first portion, may be a compound having a relatively low modulus. For example, the first material may have an M10 modulus (at 10% elongation) of no more than 1,000 PSI. The second material, forming the second portion, may be a compound having a relatively high modulus. For example, the second material may have an M10 modulus of least 2,000 PSI. M10 modulus measurements provided herein for the first and second material are taken at 10% elongation in the with grain direction and optionally in the cross grain direction (at 6 inches per minute in the with grain direction if fiber-loaded and optionally in the cross grain direction; at 20 inches per minute in the with grain direction if the compound is not fiber-loaded) and at room temperature. In some embodiments, the second material has a modulus at least about 1.8× as great as the modulus of the first material, or in other words, a ratio of high modulus to low modulus is at least 1.8. For example, 2,000 PSI to 1,000 PSI is a ratio of 2, as another example, 2,200 PSI to 1,000 PSI is a ratio of 2.2 In some embodiments, the ratio of high modulus to low modulus is between 1.8 and 25, in other embodiments between 2 and 20.

In one particular example, the first material is a polyurethane-based compound, and the second material is a nylon fabric with a polytetrafluoroethylene (PTFE) surface coating. In another particular example, the first material is a combination of polyurethane gum stock and polyurethane fiberload stock, and the second material is a nylon fabric with a PTFE surface coating.

Belt 300 of FIGS. 3A and 3B and the belts of FIGS. 4A and 4B described herein are designed to avoid “tooth jump” during use, where a tooth 310, 410 jumps out of place or otherwise does not engage or mesh correctly with the drive mechanism. The belts are sufficiently flexible and strong to transfer the power from the drive system, but sufficiently rigid and durable when under a load to inhibit “tooth jumping,” which happens when a toothed belt stretches under an applied load and slips or “jumps” in the gear. Belts having teeth extending in the elongate direction of the belt do not experience the same tooth jump, as elongate teeth are guides for the belt rather than transferers of power.

In addition to excessive stretching or elongation of a belt leading to tooth jump, excessive stretching or elongation also decreases the efficiency and durability of the belt. Excessive stretching or elongation also creates an unnecessary amount of noise as the teeth of the belt meshes with the gear. Again, belts having teeth extending in the elongate direction of the belt do not experience the same decrease in efficiency due to stretching or elongation.

The belts according to this disclosure have a limited elongation (extension, or stretch) when under load while maintaining flexibility. Such belts have a low tendency to crimp/kink, e.g., due to the flexibility of the belt body with load carrying cords. Additionally, the belts have a high modulus but with a minimal curvature coefficient.

In some embodiments, the configuration and composition of the belts as described herein provides a belt having a flexibility of at least 3 mm per 10 N of incremental load (in some embodiments 4 mm per 10 N incremental load to 6 mm of 10 N of incremental load) and having low elongation of less than 0.25% at 1,500 N of incremental load (in some embodiments less than 0.22% at 1,500 N of incremental load). The body portion (i.e., the combination of the first material used for, e.g., the base component and a portion of the teeth and the second material used for, e.g., the outer portion of the teeth) has a relatively high breaking strength, such as no less than 1,300 N/mm, in some embodiments no less than 1,400 N/mm, normalized for the width of the body portion.

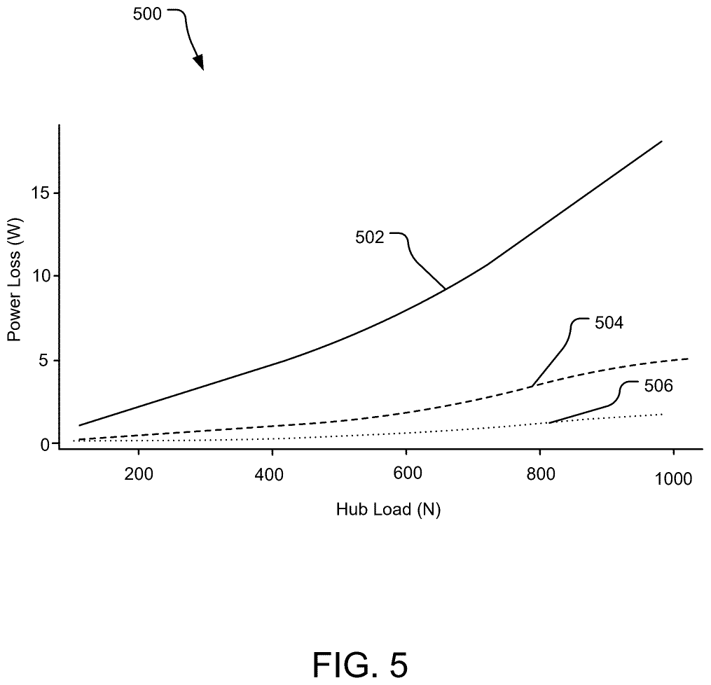

FIG. 5 provides a graphical representation 500 of belt power loss as a function of applied load for particular belts, which represents a comparison of efficiency of the belts. Data for three different belts is shown in the graph 500, two of which have significantly less power loss. In FIG. 5, the graph 500 has a data line 502 for a metal chain, a data line 504 for a first belt, and a data line 506 for a second belt.

For the metal chain of the data line 502, the graph 500 shows a steeply increasing power loss at increasing load.

The first belt (data line 504) was a cast polyurethane belt with carbon, load carrying cords. The belt is commercially available from Gates Corporation under the tradename Poly Chain® CDX™ synchronous belt.

The second belt (data line 506) was a molded rubber belt with carbon load carrying cords present in a belt body formed from two different polyurethane compounds, having two different moduli, with a nylon cover layer on the teeth with a PTFE surface coating. This second belt was the most efficient with least power lost.

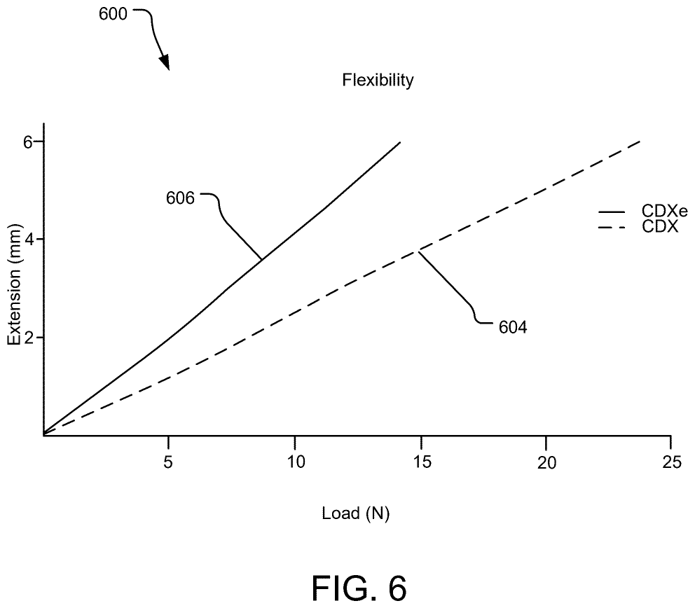

FIG. 6 provides another graphical representation 600 of belt extension as a function of applied load for particular belts, which represents a comparison of flexibility of the belts. Data for two different belts is shown in the graph 600; the graph 600 has a data line 604 for a first belt, which is the same belt as the first belt 504 of FIG. 5, and a data line 606 for a second belt, which is the same belt as the second belt 506 of FIG. 5.

From the graph 600, it is seen that the second belt (data line 606) was more flexible than the first belt (data line 604), based on a 3-point bend test.

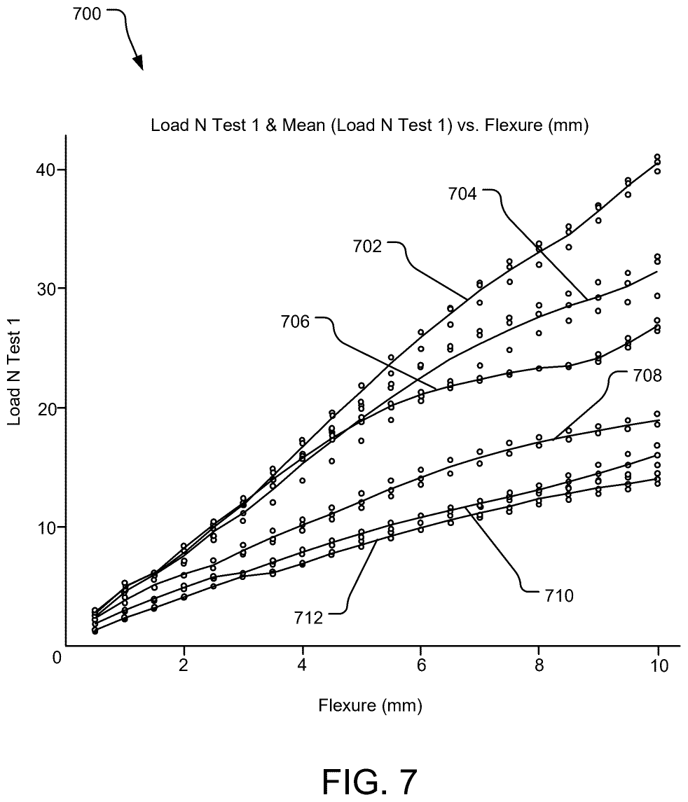

FIG. 7 provides a graph 700 showing a bending stiffness comparison based on flexibility of the belt in relation to load on the belt, also based on the 3-point bend test. Data for six different belts or chains is shown in the graph 700.

The first belt (data line 702) was a molded polyurethane belt with carbon load carrying cords, the polyurethane having a break strength no less than 1,300 N/mm.

The second belt (data line 704) was a cast polyurethane belt with carbon load carrying cord reinforcement, with the carbon cord composed of 21 intertwined strands or ends. The belt is commercially available from Gates Corporation under the tradename Poly Chain® CDX™ synchronous belt.

The third belt (data line 706) as a cast ethylene elastomeric belt with carbon load carrying cords and having a nylon cover layer with a PTFE surface coating on the teeth.

The fourth belt (data line 708) was a molded nitrile butadiene rubber (NBR) belt with carbon load carrying cords, with the carbon cord composed of 21 intertwined strands or ends. The belt is commercially available from Gates Corporation under the tradename CDN™ Urban belt.

The fifth belt (data line 710) was a molded polyurethane belt (composed of a combination of polyurethane gum stock and polyurethane fiberloaded stock) with carbon load carrying cords and having a nylon cover layer with a PTFE surface coating on the teeth.

The sixth belt (data line 712) was a cast polyurethane belt with carbon load carrying cords, the polyurethane having a breaking strength less than 1,000 N/mm.

In the graph 700, the high modulus polyurethane belt, at the top of the graph as data line 702, was the least flexible and the low modulus polyurethane belt, at the bottom of the graph as data line 712, was the most flexible. The low modulus belt (data line 712) however was so flexible that it is susceptible to tooth jump.

When the belt is sufficiently flexible but with a low elongation, the belt experiences low occurrence of tooth jump, has reduced noise due to better engagement of the belt teeth with the gear, and has extended belt durability and life. Flexible belts having too much stretch are susceptible to tooth jump. Generally, belts having a flexibility of at least 3 mm per 10 N of incremental load with an elongation or stretch less than 0.25% per 1,500 N of incremental load provide the desired operating properties. In some embodiments, the belts have a flexibility of greater than 4 mm per 10 N of incremental load and elongation less than 0.22% per 1,500 N of incremental load. Additionally or alternately, belts having a flexibility between 3 mm and 6 mm per 10 N of incremental load provide desired operating properties.

The belts 100, 200, 300 and variations thereof can be made by any suitable method. One suitable method includes mixing together raw ingredients to form a mixture; forming the mixture into a sheet; molding the sheet to form a cylinder and curing the cylinder; removing the cured cylinder from the mold and cutting the cylinder into a plurality of individual belts; and, optionally, grinding and/or profiling the belt to its final dimensions, as necessary.

Another suitable method includes mixing together raw ingredients to form the body; milling or extruding the mixture to form a sheet; calendering the sheet; bannering together several sheets of the calendered sheet; slab building a belt on a toothed mold using at least the bannered sheet; curing the belt structure in the mold to form a cylinder; removing the cured cylinder from the mold and cutting the cylinder into a plurality of individual belts; and, optionally, grinding and/or profiling the belt to its final dimensions, as necessary.

The raw ingredients, whether solid (e.g., particulate) or liquid, are mixed together to form a mixture; the ingredients may be combined sequentially, simultaneously, or in any combination thereof. The raw ingredients mixed together generally include base elastomer (polymeric material) or rubber stock, reinforcement material, filler material, binder (e.g., oil), and curing agent(s). Other adjuvants such as plasticizers, antidegradants (e.g., UV stabilizers), antistatic agents, colorants, processing aids, coagents, and the like may also optionally be added.

In some embodiments, the mixing is generally carried out using an industrial mixer, such as a Banbury mixer, to mix together all raw ingredients; however, other mixing techniques and methods can be used. In some embodiments, the individual raw ingredients are added into the mixer in a specific sequence to ensure sufficient incorporation and dispersion of the raw ingredients. In some embodiments, certain raw ingredients can be mixed together prior to being added in sequence into the mix.

With respect to the rubber stock, any suitable rubber stock can be used. In some embodiments, the rubber stock is in the form of a powder, pellet, bale or block. Exemplary suitable rubber stock includes, but is not limited to, natural rubber, styrene-butadiene rubber (SBR), chloroprene rubber (CR), ethylene elastomers (EE), ethylene propylene elastomers (e.g., EPDM and EPM) and other ethylene-elastomer copolymers such as ethylene butene (EBM), ethylene pentene and ethylene octene (EOM), nitrile butadiene rubber (NBR), hydrogenated nitrile butadiene rubber (HNBR), polyurethane elastomer (PU), chlorinated polyethylenes (CPE), and fluoroelastomers (FKM). The rubber stock may be a mixture of two or more of these materials, in varying ratios. In some embodiments, the amount of rubber stock used is from 30 wt-% to 70 wt-% of the total weight of the raw ingredients. In some embodiments, the rubber stock is from about 40 wt-% to 60 wt-% of the total weight of the raw ingredients.

In some embodiments, a polymeric material (e.g., thermoplastic or thermoset) may be used for the belts; this polymeric material may be together with or in lieu of the rubber stock. Exemplary suitable materials include, but are not limited to, polyethylene, polypropylene, polyvinyl chloride (PVD) and polyvinyl ester, polystyrene, polybenzimidazole, acrylic, nylon, urea formaldehyde, melamine formaldehyde, epoxy, and polyimide.

The belts include cords as the load carrying cord extending along the length of the belts. Details regarding inclusion of the cords in the belts are described below. The load carrying cord can be carbon cord. In other embodiments, the load carrying cord can comprise metal, ceramic, fiberglass, polybenzoxazole (PBO), aramid, nylon, polyester (PET), and any combinations thereof. The cord may have an open porosity of 10 vol-% or less, e.g., 5 vol-% or less.

In some embodiments, an additional reinforcement material (additional to the load carrying cord) may be present in the belt, for example, distributed (e.g., homogenously) throughout the rubber body. Some embodiments use fiber or filament segments or nanotubes as the reinforcement material, though other reinforcement material, such as elongated segments, can also be used. The reinforcement material may be any of, e.g., aramid, polyester (PET), cotton, nylon, glass, carbon, metal, ceramic, thermoplastic, or hybrid. The reinforcement material may be made from either organic or synthetic material, or a mixture of organic and synthetic materials.

The dimensions of the reinforcement material are generally not limited. In some embodiments, chopped fibers of reinforcement material have a high aspect ratio having a length in the range of from 0.2 mm to 3 mm. In some embodiments, the reinforcement materials (e.g., chopped fibers) have an aspect ratio of from 10 to 250. The reinforcement material is mixed with the raw ingredients and the resulting belt has the reinforcement materials homogeneously dispersed throughout. The reinforcement material is different than the elongate, load carrying cords (e.g., carbon cords 108, 208, 308).

In some embodiments of the belts described herein, a filler material such as carbon black may be used, though other filler(s) can be used, either alone or in conjunction with carbon black. Other suitable fillers include, but are not limited to clay(s), pulp(s) and silica(s). In some embodiments, the amount of filler is from 5 wt-% to 45 wt-% of the total weight of the raw ingredients that form the body. In some embodiments, the filler is from about 10 wt-% to about 20 wt-% of the total weight of the raw ingredients.

U.S. Pat. Nos. 5,610,217 and 6,616,558 provide additional information regarding material formulations and mixing methods for forming a mixture to be used in forming a belt, some or all of which may be used in forming the belts described herein. U.S. Pat. Nos. 5,610,217 and 6,616,558 are therefore incorporated herein by reference in their entirety.

The thickness of the belt described herein may vary based on the specific application for the belt.

The above specification and examples provide a complete description of the structure and use of exemplary embodiments of the invention. The above description provides specific embodiments. It is to be understood that other embodiments are contemplated and may be made without departing from the scope or spirit of the present disclosure. The above detailed description, therefore, is not to be taken in a limiting sense. For example, elements or features of one example, embodiment or implementation may be applied to any other example, embodiment or implementation described herein to the extent such contents do not conflict. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a,” “an,” and “the” encompass implementations having plural referents, unless the content clearly dictates otherwise. As used in this specification and the appended claims, the term “or” is generally employed in its sense including “and/or” unless the content clearly dictates otherwise.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

1. An endless belt comprising:
a body having a back surface and a front surface opposite the back surface;
a plurality of load carrying cords within the body; and
a plurality of teeth formed in the front surface of the body, each tooth extending across a width of the belt and the plurality of teeth running along a length of the belt;
wherein a first portion of the body extending from the back surface to at least the load carrying cords is made from a first material having an M10 modulus of no more than 1,000 PSI and wherein a second portion of the body comprising at least a portion of the teeth extending from the front surface towards the load carrying cords is made from a second material having an M10 modulus of at least 2,000 PSI, the first portion at least partially engulfing the load carrying cords.

2. The belt of claim 1, wherein the first portion having the first material fully engulfs the load carrying cords.

3. The belt of claim 2, wherein the first portion having the first material forms a portion of the teeth.

4. The belt of claim 1, wherein the load carrying cords are one or more of carbon cords, polymeric cords, fiberglass cords, metal cords, and ceramic cords.

5. The belt of claim 1, wherein the body has a break strength of no less than 1,300 N/mm.

6. The belt of claim 5, wherein the first material comprises at least one of natural rubber, styrene-butadiene rubber (SBR), chloroprene rubber (CR), ethylene propylene diene monomer rubber (EPDM), hydrogenated nitrile butadiene rubber (HNBR), ethylene elastomer copolymers, polyurethanes, fluoroelastomers, and combinations thereof.

7. The belt of claim 6, wherein the first material comprises at least two of natural rubber, styrene-butadiene rubber (SBR), chloroprene rubber (CR), ethylene propylene diene monomer rubber (EPDM), hydrogenated nitrile butadiene rubber (HNBR), ethylene elastomer copolymers, polyurethanes, fluoroelastomers, and combinations thereof.

8. The belt of claim 1, the first material further comprising a filler selected from the group consisting of carbon black, clays, pulps, silicas, and combinations thereof.

9. The belt of claim 1, wherein the second material comprises at least one of natural rubber, styrene-butadiene rubber (SBR), chloroprene rubber (CR), ethylene propylene diene monomer rubber (EPDM), hydrogenated nitrile butadiene rubber (HNBR), ethylene elastomer copolymers, polyurethanes, fluoroelastomers, and combinations thereof.

10. An endless belt comprising:
a body defining a back surface with a plurality of load carrying cords within the body, and
a plurality of teeth extending from the body opposite the back surface and defining a front surface, each tooth extending across a width of the belt and the plurality of teeth running along a length of the belt,
wherein the belt has a flexibility of at least 3 mm per 10 N of incremental load and an elongation less than 0.25% per 1,500 N of incremental load.

11. The belt of claim 10, wherein the belt has a flexibility of at least 4 mm per 10 N of incremental load.

12. The belt of claim 10, wherein the load carrying cords are one or more of carbon cords, polymeric cords, fiberglass cords, metal cords, and ceramic cords.

13. The belt of claim 10 having a break strength of no less than 1,300 N/mm.

14. The belt of claim 10, wherein the teeth comprise a high modulus rubber compound having an M10 modulus of at least 2,000 PSI and the body comprises a low modulus rubber compound having an M10 modulus of no more than 1,000 PSI.

15. An endless belt comprising:
a body defining a back surface with a plurality of load carrying cords within the body, and
a plurality of teeth extending from the body opposite the back surface and defining a front surface, each tooth extending across a width of the belt and the plurality of teeth running along a length of the belt,
wherein the belt has a flexibility between 3 mm per 10 N of incremental load and 6 mm per 10 N of incremental load.

16. The belt of claim 15, wherein the belt has a flexibility between 4 mm per 10 N of incremental load and 6 mm per 10 N of incremental load.

17. The belt of claim 15, wherein the belt has an elongation less than 0.25% per 1,500 N of incremental load.

18. The belt of claim 17, wherein the belt has an elongation less than 0.22% per 1,500 N of incremental load.
